(19) United States
(12) Patent Application Publication
(10) Pub. No.: US 2021/0071800 A1
(43) Pub. Date: Mar. 11, 2021

(54) PRESS SEAL WITH AN ELASTOMER BODY AND A TENSIONING BOLT

(71) Applicant: HAUFF-TECHNIK GMBH & CO. KG, Hermaringen (DE)

(72) Inventor: Ralf Kurz, Giengen (DE)

(73) Assignee: HAUFF-TECHNIK GMBH & CO. KG, Hermaringen (DE)

(21) Appl. No.: 17/083,737

(22) Filed: Oct. 29, 2020

Related U.S. Application Data
(63) Continuation of application No. 16/345,309, filed on Apr. 26, 2019, now abandoned.

(30) Foreign Application Priority Data
Oct. 28, 2016 (EP) 16 020 424.4

(51) Int. Cl. F16L 55/132

(52) U.S. Cl. CPC F16L 55/132; B65D 39/12

(57) ABSTRACT

The present invention relates to a compression seal (1) for insertion into and sealing of an opening (2), having an elastomer body (5) and a tensioning bolt (7), wherein the elastomer body (5) can be deformed by tightening the tensioning bolt (7) and can thus be made to press in a sealing manner in directions perpendicular to a longitudinal axis (14) of the tensioning bolt (7), and wherein a tensioning element (8) having oblique faces (9a, b) set at an angle to one another is provided for the purpose of tensioning the elastomer body (5) and is braced between the tensioning bolt (7) and the elastomer body (5) such that, by displacement in its tapering direction (11) or an opposite direction, it can be brought into a tensioning state and thus the tensioning bolt (7) can be tightened and the elastomer body (5) can be deformed.

### FIELD OF THE INVENTION

The present invention relates to a press seal having an elastomer body and a tensioning bolt, for inserting into an opening and sealing the latter.

### BACKGROUND OF THE INVENTION

From the prior art press seals are known, which have an elastomer body and a threaded bolt for tensioning, namely for deforming the elastomer body. Therein, the elastomer body can be squeezed in one direction, comparable to being arranged in a vice, whereupon it finds a sealing contact in the directions perpendicular thereto, for instance at the soffit of a wall opening. The tensioning force required hereto is applied by rotating the threaded bolt, the head of the bolt is typically provided with an outer or inner multi-edged profile for driving the bolt.

The present invention is to solve the problem to provide a particularly advantageous press seal with an elastomer body and a tensioning bolt.

### BRIEF SUMMARY OF THE INVENTION

According to the invention, this problem is solved by a press seal according to claim 1, which comprises a tensioning element for tightening the tensioning bolt.

The tensioning element has inclined faces which are inclined towards one another, and it can be or is arranged at the tensioning bolt such that it rests against the latter. By displacing the tensioning element, the tensioning bolt, which is guided at the inclined faces, can be displaced and tightened so that the elastomer body is deformed. Therein, the tensioning bolt is not tightened by a rotational movement guided in a thread, but by a force applied via the inclined faces of the tensioning element when the latter is displaced. For this purpose, the tensioning element rests against the tensioning bolt and against the elastomer body, namely with one of its inclined faces at a contact surface assigned to the tensioning bolt and with its other inclined face at a contact surface assigned to the elastomer body.

The tensioning element is preferably a wedge element, as described in detail below, wherein the inclined faces are outer wedge faces. This wedge element can be brought into the tensioned state by displacing it in the tapering direction wherein it pushes the contact surfaces away from one another (and applies a tensioning force on the tensioning bolt). However, in general, the kinematic inversion is possible as well, so that the inclined faces are oriented inwards, facing each other, the tensioning element formed comparable to a dove-tail socket. Such a tensioning element is brought into the tensioned state by a displacement in a direction opposite to the tapering direction, wherein the two contact surfaces (assigned to the tensioning bolt and to the elastomer body) are pulled towards one another.

The force required for displacing the tensioning element into the tensioned state can for example be applied by a striking tool, for instance a hammer. In comparison to screwing in a threaded bolt, this can for instance be advantageous in terms of the assembly time. Further, a hammer is a common tool on the construction site, in particular during the shell construction phase, so that no specific wrench fitting to the screwdrive of a threaded bolt has to be kept available. Besides, high tensioning forces can be generated, which enables the deformation of massive elastomer bodies.

The press seal according to the invention can in particular be used as a blind closure by which an opening in a wall or floor element, in particular in a concrete component, can be closed temporarily or permanently. Where applicable, a line can be led through the respective opening later on. For this purpose, the blind closure is removed, wherein, after leading through the line, another press seal with a through opening for the line or the same press seal can be inserted after a respective adaption (removal of a blind plug from the elastomer body).

A particularly advantageous field of application can be so-called flood openings which can be required during and after the construction of a basement, in particular of large buildings, to prevent the basement being kind of a tub from floating when the groundwater level rises significantly (during the building phase, the weight of the building can be too small in this respect). In such a situation, it is better to flood the basement with the rising groundwater through flood openings arranged for instance in the floor plate of the basement than to risk a floating and a permanent damage of the building structure. On the other hand, it is not necessary to flood the basement each time when the groundwater level rises only slightly above the level of the floor plate (which can be disadvantageous for the building material).

Therefore it is advantageous, to close a flood opening by a press seal used as a blind closure (which can also prevent an introduction of dirt). In this respect, a particular advantage of the present design can be that the tensioning element cannot only be brought simply and quickly into the tensioned state, but it can equally be brought into the untensioned state. This might even be achieved without a hammer, a stone or the like could be used as a striking tool. For instance in case of a heavy rain event, the groundwater level can rise rapidly in a short time, which can require a quick opening of the flood openings—such situations can be relevant for flood openings in general, not only in the example described here. The quick and simple demounting or mounting of a press seal according to the invention can be particularly advantageous in case of a flood opening, because it is not necessary to look for an appropriate wrench and to untighten or tighten a threaded bolt by a time-consuming rotational movement in an emergency situation (the closing of a flood opening can be time critical).

The demounting of a press seal with a tensioning element can also be advantageous compared to the untightening of a threaded bolt when water applies a certain hydraulic pressure onto the press seal. With a striking tool, the mounter can position himself aside the opening, at a certain distance thereto, namely maintain a larger safety clearance—a press seal pressed out of the opening under a pressure can be a safety hazard, and the handling of a wrench can be critical in this situation.

Also apart from these possible applications, the tensioning element and the remaining press seal can be handled as separate parts up to the mounting in the opening; if applicable, depending from the field of application or the required tensioning force, a tensioning element with an appropriate angle between the inclined faces (which determines the “gear ratio”) can be chosen. This is meant by the term “arrangeable”, namely that the tensioning element can also get arranged at the tensioning bolt not prior to the mounting of the press seal. Preferably, the tensioning element is arranged at the tensioning bolt, holding the remaining press seal together, also in the untensioned state.

The “tensioning bolt longitudinal axis” can for instance be an axis of an n-fold or complete rotational symmetry of the tensioning bolt, at least apart from a possible thread and/or a recess described below. In general, the tensioning bolt can for instance be provided with a thread at the end which lies opposite to the end with the tensioning element, for instance be respectively mounted at a press body (a “second” press body in the wording used below). However, preferably, the tensioning bolt does not have a thread. Along the “tensioning bolt longitudinal axis”, it preferably has at least a 5- or 10-fold larger extension than in each of the directions perpendicular thereto (upper limits can for instance be a 100- or 50- or 30-fold).

Along the tapering direction of the tensioning element, its inclined faces converge, but they do not necessarily meet. For instance a wedge element does not necessarily have a sharp edge at its narrow end; in contrast, for instance in view of a demounting with a striking tool, a flat narrow end can be preferred. Referring to two inclined planes, each one comprising one of the two inclined faces, the tapering direction lies perpendicular to an intersecting line, in which the two inclined planes intersect, and parallel to a center plane which divides the angle between the two inclined faces centrally into two equal halves.

The tapering direction “forming an angle” with the tensioning bolt longitudinal axis means a nonparallel orientation in general. Preferably, the tapering direction is tilted by, in the order mentioned increasingly preferred, at least 45°, 60° or 75° with respect to the tensioning bolt longitudinal axis, a possible upper limits being for instance 85°, which shall also be disclosed independently of a lower limit (from two angles enclosed by the direction and the axis, the smaller one is taken into account). The displacement “in” the tapering direction (in case of the wedge element) or in the direction opposite thereto (in case of the kinematic inversion) means that a displacement direction has at least a component parallel to the respective direction (tapering direction or opposite direction), preferably the parallel direction component has the larger share (>50%) at the corresponding direction.

In general, the elastomer body pressed or pressable into a sealing contact can also be pressed against one or several other elastomer bodies. Preferably, the elastomer body is pressed against a soffit defining the opening, wherein this soffit can for instance be formed by the wall or floor element itself, for example in case of a core drilling. However, the soffit can also be formed, namely the opening be defined, by a sleeve casted into the wall or floor element or by a frame mounted at or in the wall or floor element. Preferably, the opening is a through opening extending from one side of the wall or floor element to the opposite side.

Preferred embodiments are provided in the dependent claims and the description, without making a difference between apparatus, method and use aspects; at least implicitly, the disclosure relates to all claims categories. As far as a certain application or mounting details of the press seal are described, this relates to a corresponding use and also to a press seal adapted for a corresponding use.

In a preferred embodiment, the tensioning element is a wedge element and the inclined faces are outer wedge faces, as mentioned already. Those lie opposite to one another in a direction perpendicular to the tapering direction, facing away from each other (not facing each other, as in case of the kinematic inversion). With its outer wedge face facing away from the elastomer body, the wedge element rests against a contact surface assigned to the tensioning bolt, which is preferably formed at the tensioning bolt itself, but could in general also be formed at a part firmly attached thereto (independently of these details, this contact surface faces towards the elastomer body). With its outer wedge face facing towards the elastomer body, the wedge element contacts another contact surface, which is assigned to the elastomer body and can even be formed at the elastomer body itself, in general, even though it is preferably formed at a part transferring the tensioning force to the elastomer body, in particular a press body. Independently of these details, the tensioning bolt can preferably be tightened by displacing the wedge element with a straight movement in the tapering direction.

As far as reference is made to the orientation of a respective face “facing towards” or “facing away” from the elastomer body, this means that a surface normal pointing away from the respective face has a directional component, preferably a dominant directional component, which lies parallel to the tensioning bolt longitudinal axis and points towards the elastomer body (“facing towards”) or points away from the elastomer body (“facing away”). For instance, a face facing towards the elastomer body does not necessarily lie directly opposite thereto, instead it can also be displaced laterally (perpendicular to the tensioning bolt longitudinal axis), in particular in case of a separate tensioning device arranged laterally aside the elastomer body (see in detail below).

In a preferred embodiment, the contact surface assigned to the tensioning bolt is formed at the tensioning bolt itself, the latter being intersected by a recess, in which the wedge element is arranged. The contact surface, at which the wedge rests, defines the recess with respect to a direction parallel to the tensioning bolt longitudinal axis, facing away from the elastomer body (the recess intersects the tensioning bolt with a certain clearance from that end thereof, which faces away from the elastomer body). In a direction perpendicular to the tensioning bolt longitudinal axis, the recess extends through the tensioning bolt so that the wedge element is guided and can be displaced in the recess. With its outer face facing away from the elastomer body, the wedge element rests against the mentioned contact surface defining the recess.

In a preferred embodiment, the recess is a through hole intersecting the tensioning bolt. This through hole is enclosed by the tensioning bolt material in all directions perpendicular to an intersection direction, in which the through hole extends through the tensioning bolt. Referring to a circumference around the intersection direction, the through hole is enclosed over the whole circumference by the tensioning bolt material. The combination of a tensioning bolt with a through hole and the wedge element is mechanically robust, which can allow for applying a respectively large tensioning force.

In a preferred embodiment, the tensioning bolt is a flat body, which is preferably worked out of a flat material. Such a flat material can for instance be a sheet, in particular a sheet steel. The tensioning bolt can be cut from the sheet material, for instance by a laser beam, or it can be punched out. Accordingly, the tensioning bolt can for instance be a laser cut or punch part. In its thickness direction perpendicular to the surface directions, the flat material can for instance have a thickness of at least 1 mm, 2 mm, 3 mm or 4 mm, wherein possible upper limits (which shall also be disclosed independently thereof) can for instance be not more than 15 mm, 10 mm, 8 mm or 6 mm (in the order mentioned increasingly preferred).

Preferably the press body or bodies (see in detail below) are flat bodies as well, which is or are worked out of a flat material. Further preferred, the flat material of the press body or bodies has the same thickness as the flat material of the tensioning bolt. This can be advantageous in manufacturing, because the press body or bodies and the tensioning bolt can be worked out of the same flat material in the same processing step, which can reduce the effort in logistics. Preferably, also the tensioning element can be worked out of a flat material, which preferably has the same thickness as the flat material of the tensioning bolt and further preferred also as the press body or bodies. In general, the tensioning bolt worked out of a flat material can for instance be advantageous as its dimensions can be amended comparably easily when the press seal is designed, which can allow for an adaption of a specific press seal to specific requirements (tensioning force to be applied).

In a preferred embodiment, which can relate to the preferred wedge element but also to the kinematic inversion, the inclined faces of the tensioning element enclose a wedge angle of in the order mentioned increasingly preferred at least 2°, 4°, 6°, 8°, 10, 12°, 14°, 16, 18° or 20°. Possible upper limits can for instance be in the order mentioned increasingly preferred not more than 45, 42, 40, 38°, 36° 34°, 32° or 30°, wherein an upper limit can also be of interest independently of a lower limit (and shall be disclosed accordingly), and vice versa. In the mentioned intervals, a good trade-off between a force transmission during the tensioning and a displacement distance of the tensioning element into the tensioned state becoming not too large can be achieved. The latter can be an advantage of the present tightening approach in general which can allow for a rather compact press seal design with respect to directions perpendicular to the tensioning bolt longitudinal axis, for instance in comparison to a press seal with threaded bolts, at least when the wrench applied there is also taken into account; this can for instance be an advantage when the mounting occurs under a limited accessibility, for instance in a corner, where the wrench cannot be rotated over the whole circumference and would have to be taken off and applied repeatedly.

In a preferred embodiment, the tensioning bolt extends into the elastomer body, preferably it intersects the latter (from the front face with the tensioning element to the opposite front face). The respective press seal is adapted such that the elastomer body is compressed in the direction of the tensioning bolt longitudinal axis when the tensioning bolt is tightened, the elastomer body being consequently pressed into the sealing contact in the directions perpendicular thereto. Therein, the part of the elastomer body which is pressed into the sealing contact and that part, which is compressed axially, are preferably one-piece with each other (they cannot be separated from each other without a destruction), particularly preferred they are a monolithic part (formed of the same contiguous material). The elastomer body compressed axially preferably contacts also the tensioning bolt, which can for instance be achieved by a through hole in the elastomer body adapted to the shape of the flat body tensioning bolt (see above) or by a sufficiently large deformation of the elastomer body in case of a circular through opening.

In general, the tensioning bolt could also be arranged in a separate tensioning device provided in addition to the elastomer body; a corresponding tensioning device is inserted into the opening together with the elastomer body (and possibly further elastomer bodies), and it fills the opening together with the elastomer body or bodies; a corresponding tensioning device transfers the tensioning force perpendicularly to the tensioning bolt longitudinal axis, it is widened by tightening the tensioning bolt in the directions perpendicular thereto and presses the elastomer body or bodies perpendicularly to the tensioning bolt longitudinal axis into the sealing contact. In this embodiment, a frame, for instance made of synthetic material or metal, attached to the wall or inserted into the wall can preferably form the soffit. However, below, the option “axially compressed elastomer body, which is pressed into a sealing contact perpendicularly thereto” is discussed in further detail.

A preferred embodiment relates to a press seal with a corresponding elastomer body and a wedge element as the tensioning element, which is arranged at a first front face of the elastomer body together with a first press body. The “first” front face of the elastomer body is that one, at which the wedge element is arranged; the “second” front face lies opposite thereto with respect to a direction (“axial direction”) parallel to the tensioning bolt longitudinal axis. In the axial direction, the first press body can be displaced freely with respect to the tensioning bolt. Referring to the axial direction, the first press body is arranged between the wedge element and the elastomer body, and it is pressed against the elastomer body when the wedge element is displaced in the tapering direction. “Pressing against” does not necessarily imply a direct contact (an intermediate layer could be arranged in between), even though a direct contact is preferred.

In a preferred embodiment, the wedge element contacts the first press body directly, the first press body having preferably a contact surface for the wedge element at its front face facing away from the elastomer body and contacting the elastomer body with its opposite front face facing towards the elastomer body.

In a preferred embodiment, a second press body is arranged at the second front face of the elastomer body, the tensioning bolt interacting with the second press body for compressing the elastomer body. In the tensioned state, the tensioning bolt pulls the second press body towards the elastomer body so that the second press body is pressed against it (preferably it contacts the elastomer body directly). In general, the tensioning bolt and the second press body can also be a monolithic part, the second press body being for instance a tensioning bolt head protruding perpendicularly to the tensioning bolt longitudinal axis. However, preferably, the tensioning bolt is attached in the second press body, the two parts can for instance be welded to each other or connected by a force and/or form fit, wherein a connection based solely on a form fit is preferred.

In general, the press body, no matter whether the first or the second one, is preferably designed as a press plate, having at least a 10- or 20-fold larger extension in the directions perpendicular to the tensioning bolt longitudinal axis than axially. A preferred material is metal, which can allow for a mechanically robust design in view of a possible mounting by a striking tool.

In general, also independently of whether the press body or bodies are provided and how they are designed, the wedge element is preferably made of metal, particularly preferred made of steel. Also independently of the material, in terms of the geometry, a wedge element can be preferred, which has a broad end and/or narrow end extending perpendicularly to one of the outer wedge faces, namely preferably to the outer wedge face facing towards the elastomer body. This can be advantageous as the outer wedge face facing towards the elastomer body can be oriented basically perpendicularly to the tensioning bolt longitudinal axis during the mounting, so that the broad and/or the narrow side are oriented basically parallelly to the tensioning bolt longitudinal axis, which can allow for a good force transmission by a striking tool. At its broad end, the wedge element has a larger extension than at its narrow end.

However, in general, another wedge shape is possible as well, for instance a so called double wedge. Independently of these details, the wedge element has preferably a flat shape, namely has a thickness in a direction perpendicular to the tensioning bolt longitudinal axis and perpendicular to the tapering direction, which is smaller than the smallest extension of each outer wedge face, preferably also smaller than the extension of the narrow side. In absolute values, the thickness can for instance be not more than 15 mm, 10 mm, 8 mm or 6 mm (in the order mentioned increasingly preferred), wherein a possible lower limit can for instance be at least 4 mm (independently of the upper limits).

In general, the tensioning bolt is preferably made of a metal, particularly preferred it is made of steel. For instance in combination with a wedge element made of metal or steel, high tensioning forces can be generated.

In a preferred embodiment, which relates to the tensioning bolt with a recess for the wedge element, the recess in the tensioning bolt extends into the elastomer body in the axial direction, at least in the untightened state. A plane containing that front face of the elastomer body, which faces towards the wedge element, intersects the recess. In such an embodiment, the tensioning bolt can be moved over a comparably large distance in the axial direction, which can allow for a significant deformation of the elastomer body.

In a preferred embodiment, the tensioning element is held captive at the remaining press seal, preferably at the tensioning bolt. In case that a wedge element is the tensioning element, it can for instance be arranged in a recess or through opening of the tensioning bolt and can be secured against sliding or falling out in the direction opposite to the tapering direction, for instance by a safety pin intersecting the wedge element. In general, for instance a safety chain is possible as well, which can hold the tensioning element at the remaining press seal, in particular at the tensioning bolt.

In a preferred embodiment, a locking member is provided for locking the tensioning element in the tensioned state, it impedes or blocks a displacement of the tensioning element opposite to the tapering direction (in case of the wedge element) or in the tapering direction (in case of the kinematic inversion). Preferably, the tensioning element is provided with a hole, particularly preferred with a row of holes (a plurality of holes arranged in a row), wherein a displacement out of the tensioned state is blocked by inserting a locking pin into the hole or into one of the holes (after a small displacement, the locking pin would contact the tensioning bolt and prevent a further displacement). A row of holes can be advantageous as it can allow a locking of different tensioned states, in which the elastomer body is deformed to a different extent.

In a preferred embodiment, the elastomer body is a blind closure, it does not receive a line led through the opening. Therein, in general, the elastomer body can be adapted for leading a line through later on, namely it can comprise a removable or detachable blind closure, preferably it is designed as a permanent blind closure and does not comprise separating lines or predetermined breaking points. Preferably the elastomer body is, apart from a through opening in which the tensioning bolt is provided (or a plurality of through openings in case of a plurality of tensioning bolts) a contiguous part without interruptions, which can allow for a robust design. In general, however, the press seal can also be adapted for leading through one or a plurality of lines, wherein the deformed elastomer body is not only pressed against the soffit but also against the line(s) led through.

Independently of these details, the press seal preferably comprises only a single tensioning bolt, which is further preferred arranged centrally in the elastomer body with respect to directions perpendicular to the tensioning bolt longitudinal axis. The tensioning bolt longitudinal axis can preferably be an axis for an n-fold rotational symmetry, particularly preferred a complete rotational symmetry. This can allow for a uniform distribution of the tensioning forces.

The invention also relates to a use of a press seal for inserting it into an opening and sealing the latter by tensioning the tensioning bolt, namely by displacing the tensioning element in the tapering direction (wedge element) or in the direction opposite thereto (kinematic inversion). By displacing the wedge element from the untightened into the tensioned state, the center of mass of the wedge element is displaced, preferably with a straight movement which forms an angle (see the definitions above) with the tensioning bolt longitudinal axis. This shall also be disclosed in terms of a respectively designed press seal, and regarding the use reference is also made to the description above.

In a preferred embodiment, the force for displacing the tensioning element is applied by striking, preferably by a striking tool, particularly preferred by a hammer.

Independently of these details, a use can be preferred, wherein a plurality of openings assigned to the same structural shell are respectively closed by a press seal with a wedge element, as disclosed here, for instance at least 10, 20 or 30 openings. Therein, the comparably fast and simple mounting of a respective press seal, for instance by a single strike, can be relevant. A field of application can be so called table shafts or transformer stations. Even though basically any number of openings could be sealed by a respective press seal, possible upper limits (of the number of openings in a single structural shell) can for instance be not more than 1000, 500 or 200 openings.

Below, the invention is described by means of an exemplary embodiment, wherein the individual features can also be relevant for the invention, within the scope of the independent claims, in a different combination, and wherein the description relates to all claims categories.

### BRIEF DESCRIPTION OF THE DRAWINGS

In detail,

FIG. 1 shows a press seal according to the invention with a wedge element in the untightened state;

FIG. 2 shows a press seal according to FIG. 1 with the wedge element in the tensioned state.

### DETAILED DESCRIPTION OF THE PREFERRED EMBODIMENTS

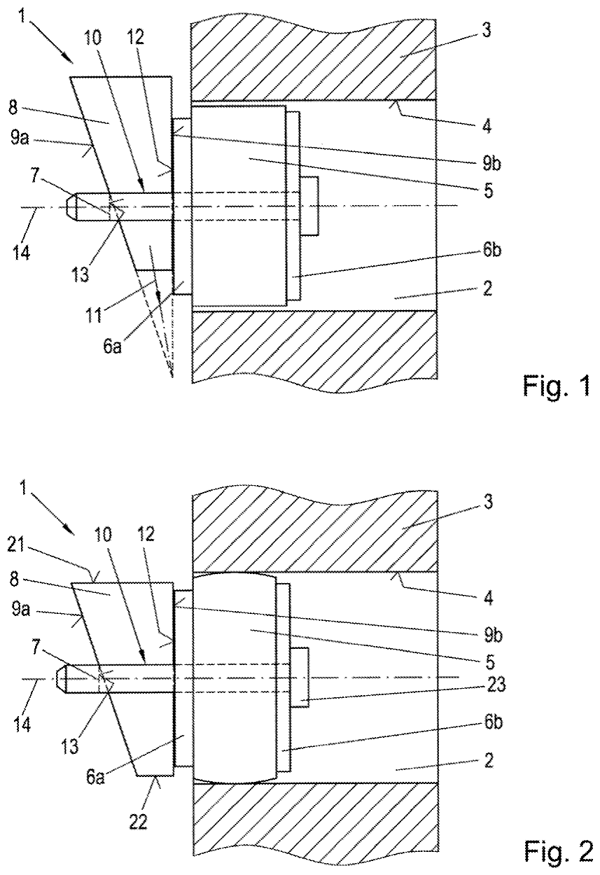

FIG. 1 shows a press seal 1 which is inserted into an opening 2 in a wall 3, a wall 3 made of concrete in this example. The opening 2 can be formed as a core drilling or it can be kept free when the wall 3 is casted from concrete, anyhow the wall 3 itself forms a soffit 4 which defines the opening 2. The press seal 1 is adapted as a blind closure, as such it seals the opening 2.

The press seal 1 comprises an elastomer body 5 which is compressed axially for the sealing and consequently contacts the soffit 4 in directions perpendicular to the axial direction. For this purpose, a respective press body 6a,b formed as a press plate is arranged at each of the two front faces of the elastomer body 5, wherein the press bodies 6a,b can be moved axially towards each other by tightening the tensioning bolt 7, for deforming the elastomer body 5 in between axially. In this example, a tensioning bolt 7 having to a large extent a rotationally symmetrical design is shown; likewise, the tensioning bolt 7 could be a flat body worked out of a flat material.

According to the invention, a tensioning element 8 is provided for tightening the tensioning bolt 7, which comprises inclined faces 9a,b which are inclined towards one another. In this example, the tensioning element 8 is a wedge element, and the inclined faces 9a,b are outer wedge faces. The wedge element is arranged in a recess 10 in the tensioning bolt 7, a through hole in this example (in this side view, the recess 10 is not visible, it extends vertically through the tensioning bolt 7 in this figure).

The two inclined faces 9a,b of the wedge element 8 converge along the tapering direction 11. The tensioning element 8 formed as a wedge element can be brought into the tensioned state by a displacement in the tapering direction 11 (with a predominant directional component parallel to the tapering direction 11). Thereby, a contact surface 12 of the first press body 6a arranged on the left in the figure, which is contacted by the inclined face 9b of the wedge element facing towards the elastomer body 5, and a contact surface 13 of the tensioning bolt 7, which is contacted by the other inclined face 9a of the wedge element, are moved away from each other axially. Accordingly, the two press bodies 6a,b are moved towards each other axially, namely along the tensioning bolt longitudinal axis 14, and the elastomer body 5 is compressed axially.

FIG. 2 shows the press seal 1 in the tensioned state, wherein the tensioning element 8 is already displaced and the elastomer body 5 is compressed axially and widened perpendicularly thereto. In this tensioned state, the wedge element could be locked by a locking pin (not shown), which could be inserted into a hole arranged slightly below the tensioning bolt 7 in FIG. 2. In case of the wedge element shown here, a broad side 21 and a narrow side 22 extend basically perpendicularly to the inclined face 9b which faces towards the elastomer body 5. For bringing the wedge element into the tensioned state, the broad side 21 is hit by a hammer or another striking tool. For moving the wedge element from the tensioned state shown in FIG. 2 into an untensioned state, the striking force is applied onto the narrow side 22.

The tensioning bolt 7 and also the wedge element are made of steel. The force generated by the tensioning bolt 7 and the wedge element is transferred onto the elastomer body 5 via the press bodies 6a,b which are also made of metal. At its end assigned to the second press body 6b, the tensioning bolt 6 has a broadened tensioning bolt head 23 for engaging at the second press body 6b and moving it axially. The first press body 6a is intersected by the tensioning bolt 7, it is guided axially displaceable at the latter.

1. A press seal (1) for inserting into an opening (2) and sealing the latter, having
an elastomer body (5) and
a tensioning bolt (7),
wherein the elastomer body (5) is deformable by tightening the tensioning bolt (7) such that the elastomer body (5) can be pressed into a sealing contact in directions perpendicular to a longitudinal axis (14) of the tensioning bolt (7),
characterized in that
the press seal (1) comprises a tensioning element (8) with inclined faces (9a, b) which are inclined towards one another, the tensioning element (8) being arranged or arrangeable at the tensioning bolt (7) such that a tapering direction (11) of the tensioning element (8), along which the inclined faces (9a, b) converge, forms an angle with the tensioning bolt longitudinal axis (14), wherein the tensioning element (8) rests against the tensioning bolt (7) and the elastomer body (5) such that the tensioning element (8) can be brought into a tensioned state by displacing it in the tapering direction (11) or in a direction opposite thereto, whereby the tensioning bolt (7) can be tightened and the elastomer body (5) can be deformed.

2. The press seal (1) according to claim 1, wherein the tensioning element (8) is a wedge element, the inclined faces (9a, b) being outer wedge faces of the wedge element, wherein the wedge element can be brought into the tensioned state by a displacement in the tapering direction (11).

3. The press seal (1) according to claim 2, wherein a recess (10) intersects the tensioning bolt (7), preferably a trough-hole, the wedge element being arranged or arrangeable in the recess (10) such that the wedge element rests against a bearing surface (13) of the tensioning bolt (7) with one (9a) of its outer wedge faces (9a, b), which are inclined towards one another, the bearing surface (13) defining the recess (10) with respect to a direction, which lies parallel to the tensioning bolt longitudinal axis (14) and points away from the elastomer body (5).

4. The press seal (1) according to claim 1, wherein the tensioning bolt (7) is a flat body, which is preferably worked out of a flat material.

5. The press seal (1) according to claim 1, wherein the inclined faces (9a, b) of the tensioning element (8), which are inclined towards one another, form an angle with each other of at least 2° and not more than 45°.

6. The press seal (1) according to claim 1, wherein the tensioning bolt (7) extends into the elastomer body (5), preferably intersecting the latter, the press seal (1) being adapted such that the elastomer body (5) is compressed in the direction of the tensioning bolt longitudinal axis (14) and, consequently, brought into the sealing contact in the directions perpendicular thereto when the tensioning bolt (7) is tightened.

7. The press seal (1) according to claim 2, wherein the wedge element is arranged at a first front face of the elastomer body (5) together with a first press body (6a) of the press seal (1), wherein the first press body (6a) is arranged between the wedge element and the elastomer body (5) with respect to a direction parallel to the tensioning bolt longitudinal axis (14), the first press body (6a) being pressed against the elastomer body (5) by the wedge element when the latter is displaced in the tapering direction (11).

8. The press seal (1) according to claim 7, wherein the wedge element directly contacts, with that one of its outer wedge faces inclined towards one another, which faces the elastomer body (5), a contact surface (12) of the first press body (1).

9. The press seal (1) according to claim 7, wherein a second press body (6b) is arranged at a second front face of the elastomer body (5), which lies opposite to a first front face of the elastomer body (5) at which the wedge element is arranged, the tensioning bolt (7) interacting with the second press body (6b) for compressing the elastomer body (5).

10. The press seal (1) according to claim 3, wherein the recess (10) in the tensioning bolt (7) extends into the elastomer body (5) in a direction parallel to the tensioning bolt longitudinal axis (14), at least in an untightened state of the tensioning bolt (7).

11. The press seal (1) according to claim 1, wherein the tensioning element (8) is held captive at the remaining press seal (1), preferably at the tensioning bolt (7).

12. The press seal (1) according to claim 1, further comprising a locking member, the tensioning element (8) being lockable in the tensioned state by the locking member, preferably by a locking pin in combination with a hole in the tensioning element (8), wherein a displaceability of the tensioning element (8) is lockable by inserting the locking pin into the hole.

13. The press seal (1) according to claim 1, wherein the elastomer body (5) is adapted as a blind closure.

14. A method of using a press seal (1) according to claim 1 comprising the steps of:
inserting said press seal (1) into an opening (2); and
sealing said opening (2) by tightening the tensioning bolt (7) by displacing the tensioning element (8) arranged at the tensioning bolt (7) in the tapering direction (11) or in the direction opposite thereto.

15. The method of claim 14 wherein the tensioning element (8) is displaced into the tensioned state by a force applied by striking, preferably by a striking tool.
